(19) United States
(12) Patent Application Publication
(10) Pub. No.: US 2024/0342945 A1
(43) Pub. Date: Oct. 17, 2024

(54) IMMERSION TREATMENT SYSTEM FOR ITEMS AND METHOD

(71) Applicant: TECHNOLOGIES BORALIFE INC, Sorel-Tracy (CA)

(72) Inventors: Stephane ROMPRE, Quebec (CA); Haithem BEN AYED, Saint-Augustin-de-Desmaures (CA); Laury TREMBLAY, Quebec (CA)

(73) Assignee: TECHNOLOGIES BORALIFE INC, Sorel-Tracy, QC (CA)

(21) Appl. No.: 18/705,751

(22) PCT Filed: Oct. 27, 2022
(86) PCT No.: PCT/CA2022/051598

§ 371 Date: Apr. 29, 2024

Related U.S. Application Data
(60) Provisional application No. 63/263,257, filed on Oct. 29, 2021.

(51) Int. Cl. B27K 3/04; B05D 1/18

(52) U.S. Cl. CPC B27K 3/04; B05D 1/18; B05D 2203/20

(57) ABSTRACT

An immersion treatment system for treating items, comprising a shipping container, a treatment tank insertable in the shipping container and defining a treatment chamber, an item-receiving receptacle displaceable between a loading/unloading configuration where the item-receiving receptacle extends outside the treatment chamber and a treatment configuration where the item-receiving receptacle is positioned in the treatment chamber, and a lift at least partially insertable in the shipping container and including a receptacle connector assembly. The treatment chamber is being adapted to receive a treatment solution. The item-receiving receptacle is being engageable with the receptacle connector assembly and translatable between the loading/unloading configuration and the treatment configuration. A method for treating items by immersion is also described.

### CROSS-REFERENCE TO RELATED APPLICATIONS

This application claims priority under 35USC § 119 (e) of U.S. provisional patent application 63/263,257 filed on Oct. 29, 2021, the specification of which is hereby incorporated by reference.

### TECHNICAL FIELD

The present disclosure relates generally to the field of immersion treatment systems. More particularly, it relates to a system for treating items such as lignocellulosic material pieces by immersion, and a method for treating such items.

### BACKGROUND

Items such as wood pieces, including planks, lumbers, boards, strips, battens, plywood, panels, and the like, might require to be treated by immersion in a liquid-based treatment solution. For efficiency purposes, the items must be bundled in a group of items and immersed in the treatment solution. The systems adapted to treat by immersion bundle items such as wood bundles are complex to install and set up as they normally require a large treatment vessel containing the treatment solution and a lift to operate such bundled items in and out of the treatment solution. Immersion treatment systems known in the art are therefore normally fixed, cumbersome and permanent installations, built and installed on a given site where the processing operation will take place.

There is also currently a demand in developing countries for such treatment systems but the resources and the material and equipment to build these systems over there are very often lacking. It would therefore be desirable to find an efficient and inexpensive solution that would allow to acquire such equipment easily and quickly.

In view of the above, there is a need for an improved immersion treatment system for items such as and without being limitative wood planks, which by virtue of its design and components, would be able to satisfy at least the above-discussed drawback.

### SUMMARY

According to a first general aspect, there is provided an immersion treatment system for treating items. The immersion treatment system comprises: a shipping container; a treatment tank insertable in the shipping container and defining a treatment chamber, the treatment chamber being adapted to receive a treatment solution; an item-receiving receptacle displaceable between a loading/unloading configuration where the item-receiving receptacle extends outside the treatment chamber and a treatment configuration where the item-receiving receptacle is positioned in the treatment chamber; and a lift at least partially insertable in the shipping container and including a receptacle connector assembly, and wherein the item-receiving receptacle is being engageable with the receptacle connector assembly and translatable between the loading/unloading configuration and the treatment configuration.

In an embodiment, the lift comprises two telescopic posts extending vertically, the receptacle connector assembly being connected to the telescopic posts and configured to receive the item-receiving receptacle in between, each one of the two telescopic posts being slidable in sync between an extended configuration and a retracted configuration; and an actuation assembly operatively connected to the two telescopic posts to configure the two telescopic posts between the retracted configuration and the extended configuration.

In an embodiment, the lift further comprises a horizontally extending beam mounted to the two telescopic posts and extending between an upper segment of each of the two telescopic posts; and wherein the receptacle connector assembly comprises a first receptacle support arm and a second receptacle support arm both extending downwardly from the horizontally extending beam, the item-receiving receptacle being engageable with the first receptacle support arm and the second receptacle support arm at opposed longitudinal ends thereof.

In an embodiment, the two telescopic posts being in the extended configuration corresponds to the loading/unloading configuration when the item-receiving receptacle is engaged with the receptacle connector assembly, and the two telescopic posts being in the retracted configuration corresponds to the treatment configuration when the item-receiving receptacle is engaged with the receptacle connector assembly.

In an embodiment, the lift further comprises a slide track assembly extending horizontally adjacent to the treatment tank, the slide track assembly comprising a rail structure and a carriage structure, the carriage structure being slidable between an aligned position where the carriage structure is vertically aligned with the treatment tank and an offset position where the carriage structure is located on a lateral side of the treatment tank, the two telescopic posts being mounted to the carriage structure.

In an embodiment, the two telescopic posts being in the retracted configuration and the carriage structure being in the offset position corresponds to the loading/unloading configuration when the item-receiving receptacle is engaged with the receptacle connector assembly, and the two telescopic posts being in the retracted configuration and the carriage structure being in the aligned position corresponds to the treatment configuration when the item-receiving receptacle is engaged with the receptacle connector assembly.

In an embodiment, the lift comprises articulated arms pivotally securable to the shipping container, the receptacle connector assembly being connectable to the articulated arms and configured to receive the item-receiving receptacle in between, each one of the articulated arms being pivotable in sync and selectively configurable between an engagement/disengagement configuration to engage the item-receiving receptacle configured in the loading/unloading configuration and a treatment configuration wherein the articulated arms are vertically substantially aligned with the treatment tank; and at least one arm actuator operatively connected to the articulated arms and being actuable to configure the articulated arms selectively in the engagement/disengagement configuration and the treatment configuration.

In an embodiment, the item-receiving receptacle comprises a cage to maintain the items in a bundle, the cage including a door configurable in an open configuration allowing the items to be loaded and unloaded.

In an embodiment, the item-receiving receptacle is rotatably mounted to the receptacle connector assembly.

In an embodiment, the treatment tank comprises an open top communicating with the treatment chamber allowing access to the item-receiving receptacle.

In an embodiment, the treatment system further comprises a treatment solution heating assembly.

According to another general aspect, there is provided a method for treating items by immersion, comprising the steps of:
a) providing an immersion treatment system as described above;
b) loading items in the item-receiving receptacle;
c) displacing the item-receiving receptacle from the loading/unloading configuration to the treatment configuration;
d) treating the items with the treatment solution contained in the treatment chamber and obtaining treated items;
e) displacing the item-receiving receptacle from the treatment configuration to the loading/unloading configuration; and
f) unloading the treated items from the item-receiving receptacle.

In an embodiment, the step of loading items in the item-receiving receptacle further comprises a step of displacing the item-receiving receptacle from the treatment configuration to the loading/unloading configuration if the item-receiving receptacle is in the treatment configuration.

In an embodiment, the item-receiving receptacle comprises a cage to maintain the items in a bundle; and the step of loading items in the item-receiving receptacle further comprises loading the items through a door in the cage.

In an embodiment, the step of unloading the treated items from the item-receiving receptacle further comprises unloading the items through the door in the cage.

In an embodiment, the step of treating the items with the treatment solution contained in the treatment chamber further comprises rotating the item-receiving receptacle in the treatment chamber.

In an embodiment, the step of displacing the item-receiving receptacle from the treatment configuration to the loading/unloading configuration further comprises the step of holding the item-receiving receptacle outside the treatment tank and above the treatment tank to drain the treatment solution.

In an embodiment, the method further comprises the step of heating the treatment solution.

Thanks to its design and components, the above-described immersion treatment system for items can be easily transported from one treatment site to another and it is easy to install on a treatment site. The immersion treatment system proposed is a complete, all inclusive and portable system to proceed with the treatment right after installation.

### BRIEF DESCRIPTION OF THE DRAWINGS

The accompanying drawings, which are incorporated in and constitute a part of the specification, illustrate embodiments and together with the detailed description herein, serve to explain the principles of the realization. The drawings are only for purposes of illustrating embodiments and are not to be construed as limiting the realization. It is emphasized that, in accordance with the standard practice in the industry, various features are not drawn to scale. The foregoing and other objects, features and advantages of the realization are apparent from the following detailed description taken in conjunction with the accompanying drawings in which:

FIGS. 1 to 3 are cross-sectional side views of an immersion treatment system, in accordance with an embodiment, installed below a floor level with a top of a shipping container extending substantially at a same height than the floor level, and showing a possible sequence of steps for treating items therewith. FIG. 1 shows an item-receiving receptacle outside of a treatment tank, in a loading/unloading (first) configuration, ready to be loaded with items, FIG. 2 shows the item-receiving receptacle loaded with the items to be treated and ready to be lowered into the treatment tank and FIG. 3 shows the item-receiving receptacle positioned in the treatment tank, in a treatment (second) configuration.

FIG. 4 is a front elevation view of the immersion treatment system of FIGS. 1 to 3, partly sectioned, and showing the item-receiving receptacle in the loading/unloading configuration as in FIGS. 1 and 2.

FIG. 5 is a front elevation of the immersion treatment system of FIGS. 1 to 3, partly sectioned, showing the item-receiving receptacle in the treatment configuration as in FIG. 3.

FIG. 6 is a side elevation view of the treatment system of FIGS. 1 to 3.

FIG. 7 is a side elevation view, partially sectioned, of the immersion treatment system in accordance with another embodiment, wherein the treatment tank is removed from the shipping container and supported on the floor.

FIGS. 8 to 11 are side elevation views, partially sectioned, of the immersion treatment system shown in FIG. 7, showing a possible sequence of steps for treating items therewith.

FIG. 8 shows items to be treated loaded in the item-receiving receptacle located outside of the treatment tank in the loading/unloading configuration, FIG. 9 shows the item-receiving receptacle located above and beside treatment tank, FIG. 10 shows the item-receiving receptacle located above and over the treatment tank, and FIG. 11 shows the item-receiving receptacle positioned in the treatment tank, in the treatment configuration.

FIG. 12 is a perspective view of an immersion treatment system according to another embodiment, showing only the lift and the treatment tank.

FIGS. 13 to 17 are side elevation views of the immersion treatment system, in accordance with still another embodiment, and showing a possible sequence for treating items therewith. FIG. 13 shows the item-receiving receptacle located outside of the treatment tank, in a loading/unloading configuration, ready to be loaded with items, FIG. 14 shows the item-receiving receptacle located outside of the treatment tank in the loading/unloading configuration and loaded with items to be treated (not shown), FIG. 15 shows the item-receiving receptacle located above and beside the treatment tank, FIG. 16 shows the item-receiving receptacle located above and over the treatment tank, and

FIG. 17 shows the item-receiving receptacle positioned in the treatment tank, in the treatment configuration.

FIG. 18 is a side elevation view, partially sectioned, of the immersion treatment system of FIGS. 13 to 17, in the treatment configuration where the item-receiving receptacle is in rotation in the treatment tank.

FIG. 19 is a perspective view of the immersion treatment system of FIGS. 13 to 18, showing the item-receiving receptacle located above and beside the treatment tank.

FIG. 20 is a top plan view of the immersion treatment system of FIGS. 13 to 19, showing the item-receiving receptacle located above and beside the treatment tank.

FIG. 21 is a front elevation view of the immersion treatment system of FIGS. 13 to 20, showing the item-receiving receptacle located above and beside the treatment tank.

FIG. 22 is a perspective view of a treatment tank extracted from the shipping container of FIGS. 1 to 19.

FIG. 23 is a top plan view of the treatment tank of FIG. 22, showing a heating assembly, in accordance with an embodiment.

FIG. 24 is a cross section view of the treatment tank of FIGS. 22 and 23, showing the heating assembly.

FIG. 24A is an enlarged view of portion A shown in FIG. 24.

FIG. 25 is a flowchart of a method for treating items by immersion, in accordance with an embodiment, using the immersion treatment system of anyone of FIGS. 1 to 24.

### DETAILED DESCRIPTION

Various features and advantages of the immersion treatment system will be better understood upon a reading of embodiments thereof with reference to the appended drawings.

It is worth noting that the same numerical references refer to similar elements. In addition, for the sake of simplicity and clarity, namely so as to not unduly burden the figures with several references numbers, not all figures contain references to all the components and features, and references to some components and features may be found in only one figure, and components and features of the present disclosure which are illustrated in other figures can be easily inferred therefrom. The embodiments, geometrical configurations, materials mentioned and/or dimensions shown in the figures are optional and are given for exemplification purposes only.

Moreover, although the embodiments of the treatment system and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation there in between, as well as other suitable geometrical configurations, may be used for the device, as will be briefly explained herein and as can be easily inferred therefrom by a person skilled in the art.

Moreover, it will be appreciated that positional descriptions such as “above”, “below”, “forward”, “rearward”, “left”, “right”, and the like should, unless otherwise indicated, be taken in the context of the figures and correspond to the position and orientation of the wood treatment system as disclosed herein. Positional descriptions should not be considered limiting.

In the following description, there is described a first embodiment related to an immersion treatment system (or item treatment system), such as and without being limitative a lignocellulosic-material treatment system.

Referring to the drawings and more particularly to FIGS. 1 to 3, there is shown an embodiment of an immersion treatment system (10) for treating items (80), such as lignocellulosic material pieces. For instance and without being limitative, the lignocellulosic material pieces can include solid wood planks, lumber, boards, strips, battens, and the like. The immersion treatment system (10) comprises a shipping container (20) and a treatment tank (30) insertable in the shipping container (20). The treatment tank (30) defines a treatment chamber (31) adapted to receive a liquid-based treatment solution (not shown). The treatment tank (30) has an open top (33) communicating with and providing access to the treatment chamber (31). As the treatment tank (30), the shipping container (20) can be configured in an open configuration, wherein it is opened at the top to provide access to the treatment tank (30) and, more particularly, to the open top (33) of the treatment tank (30).

In the non-limitative embodiment shown, when contained in the shipping container (20), a bottom wall of the treatment tank (30) is supported by the floor of the shipping container (20) and peripheral walls of the treatment tank (30) extend substantially parallel and adjacent to peripheral walls of the shipping container (20). In an embodiment, the treatment tank (30) can be shorter in length than the shipping container (20) to further contain other equipment, such as heaters, pumps, hoses, pipes, power unit for actuators etc., of the immersion treatment system (10), as will be described in more details below.

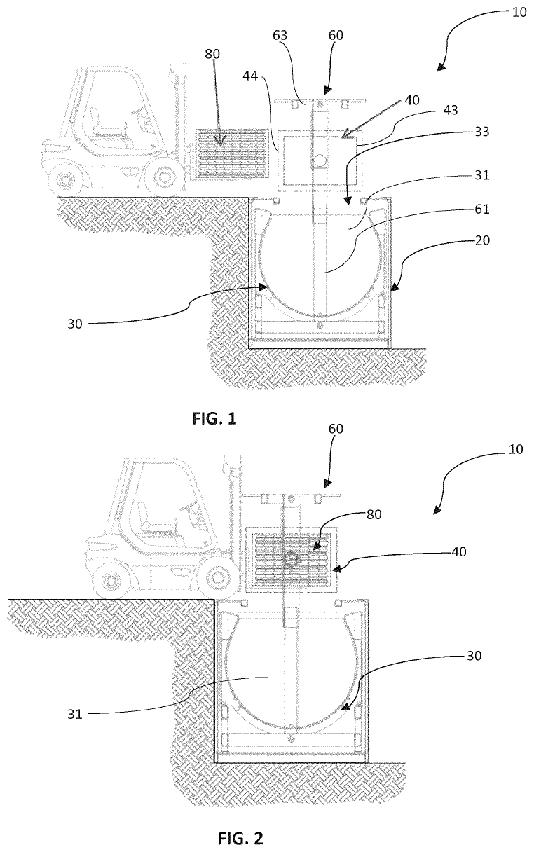

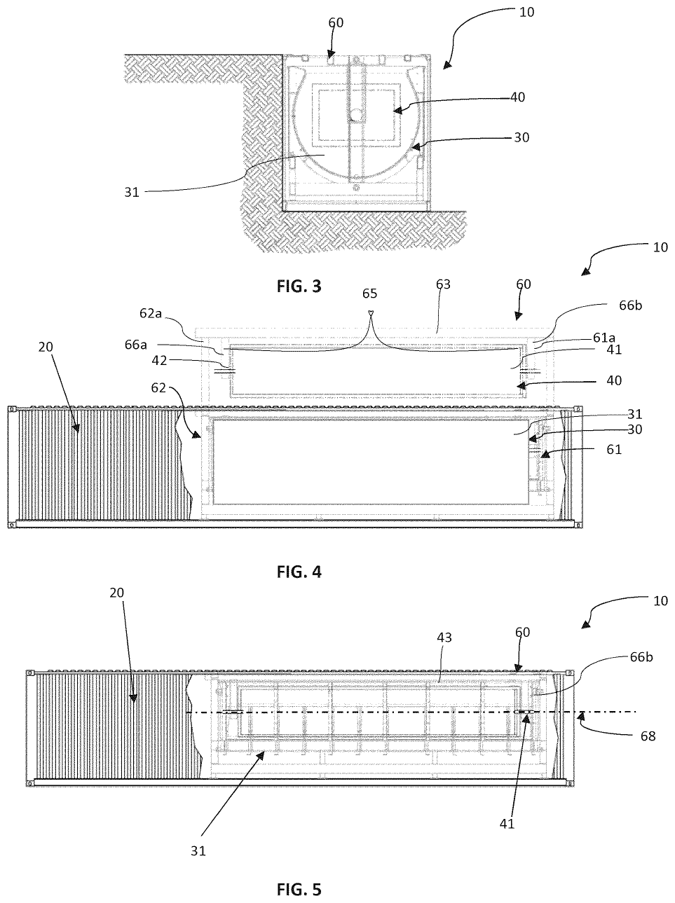

The treatment system (10) further comprises an item-receiving receptacle (40) movable between at least a loading/unloading (or first) configuration, as shown in FIGS. 1 and 2, where the item-receiving receptacle (40) is located outside the treatment chamber (31), in a configuration to be loaded with items to be treated and unloaded from treated item, and a treatment (or second) configuration, as shown in FIG. 3, where the item-receiving receptacle (40) is positioned in the treatment chamber (31), at least partially immersed in the liquid-based treatment solution. The item-receiving receptacle (40) is displaced and, more particularly, translated in the non-limitative embodiment shown, between the loading/unloading configuration and the treatment configuration via the open top (33) of the treatment tank (30). It is appreciated that the item-receiving receptacle (40) can include more than one loading/unloading configuration and/or treatment configuration.

The treatment system (10) further comprises a lift (60), acting as receptacle displacement assembly between the loading/unloading configuration and the treatment configuration. The lift (60) is at least partially insertable in the shipping container (20). It includes, amongst others, a receptacle connector assembly (65), shown in FIG. 4. The item-receiving receptacle (40) is engageable with the receptacle connector assembly (65) to be translated between the loading/unloading configuration, shown in FIG. 1, to the treatment configuration, shown in FIG. 3 and as will be described in more details below. In other words, when engaged with the receptacle connector assembly (65), the item-receiving receptacle (40) is displaced simultaneously therewith.

Turning now to FIGS. 4 and 5, in the non-limitative embodiment shown, the lift (60) further comprises two telescopic posts (61, 62) extending vertically and spaced-apart from one another. More particularly, each one of the telescopic posts (61, 62) is located at a respective longitudinal end of the treatment tank (30), outwardly thereof.

Each one of the two telescopic posts (61, 62) are slidable in sync between an extended configuration and a retracted configuration corresponding respectively to the loading/unloading configuration (FIG. 4) and the treatment configuration (FIG. 5) mentioned above. In the extended configuration, a section of each one of the two telescopic posts (61, 62) extends outwardly of the shipping container (20) and above the treatment tank (30), as shown in FIG. 4. In the treatment configuration, the two telescopic posts (61, 62) are contained inside the shipping container (20). The lift (60) also comprises a lift actuation assembly (not shown) operatively connected to the two telescopic posts (61 and 62) to configure same between the retracted configuration and the extended configuration. Such actuation assembly can include hydraulic cylinders, pneumatic actuators, electric actuators, mechanical actuators, or any other type of actuators.

In the non-limitative embodiment shown, each one of the two telescopic posts (61, 62) comprises three segments (i.e. a base segment, an intermediate segment, and an upper segment (61a and 62a)) translatably engaged with one another.

In the non-limitative embodiment shown, the lift (60) also comprises a horizontally extending beam (63) extending between and connecting the two telescopic posts (61 and 62). More particularly, the horizontally extending beam (63) is mounted to an upper end of the upper segment (61a and 62a) of each of the two telescopic posts (61 and 62). Therefore, the height of horizontally extending beam (63) varies simultaneously with the configuration of the telescopic posts (61 and 62).

In the embodiment shown, the receptacle connector assembly (65) is mounted to the horizontally extending beam (63), as best viewed from FIGS. 4 and 5, the receptacle connector assembly (65) comprises a first receptacle support arm (66a) and a second receptacle support arm (66b), both extending downwardly from the horizontally extending beam (63), being spaced-apart from one another. More particularly, the first and second receptacle support arms (66a, 66b) are spaced-apart from one another by a distance such that the item-receiving receptacle (40) can be inserted in-between and be located at least partially inside the treatment tank (30) in the treatment configuration, where the two telescopic posts (61 and 62) are retracted and contained inside the shipping container (20). The receptacle connector assembly (65) further comprises first and second receptacle connectors (41, 42) mounted to a respective one of the first and second receptacle support arms (66a, 66b), close to a free end thereof. The item-receiving receptacle (40) is engageable with the first and second receptacle connectors (41, 42) of the receptacle connector assembly (65) to be translated between the loading/unloading configuration and the treatment configuration. In the non-limitative embodiment shown, the receptacle connectors (41, 42) are pivot connectors configured to engage in at least a partial rotation the item-receiving receptacle (40) about an axis defined by the first and second receptacle connectors (41, 42). It is appreciated that the item-receiving receptacle (40) can rotate about the first and second receptacle connectors (41, 42) or that the first and second receptacle connectors (41, 42) rotate about the first and second receptacle support arms (66a, 66b).

Each one of the telescopic posts (61, 62) are connected to a portion of the receptacle connector assembly (65), namely to each of the extremity of the horizontally extending beam (63). Thus, when the item-receiving receptacle (40) is engaged with the receptacle connector assembly (65) provided on both telescopic posts (61, 62), it is located between the telescopic posts (61, 62) and vertically aligned with the treatment tank (30). In the loading/unloading configuration of the non-limitative embodiment shown, it extends above the open top (33) of the treatment tank (30) while, in the treatment configuration, it is contained in the treatment chamber (31) defined by treatment tank (30).

The receptacle connector assembly (65) is mounted to an upper end of the upper segment (61a and 62a) of the two telescopic posts (61, 62) and translate therewith between the retracted configuration (wherein the three segments are nested within each other as shown in FIG. 3) and the extended configuration (wherein the intermediate segment and the upper segment (61a and 62a) are offset from the base segment). It is appreciated that, in an alternative embodiment, the two telescopic posts (61, 62) can be static and the receptacle connector assembly (65) can be translated along the two telescopic posts (61, 62) by another means of translation, such as belt/pulleys, chain/gears, chain hoist, cable(s), rope(s) or any other type of support assembly capable of translating the item-receiving receptacle (40) vertically with respect to the treatment tank (30).

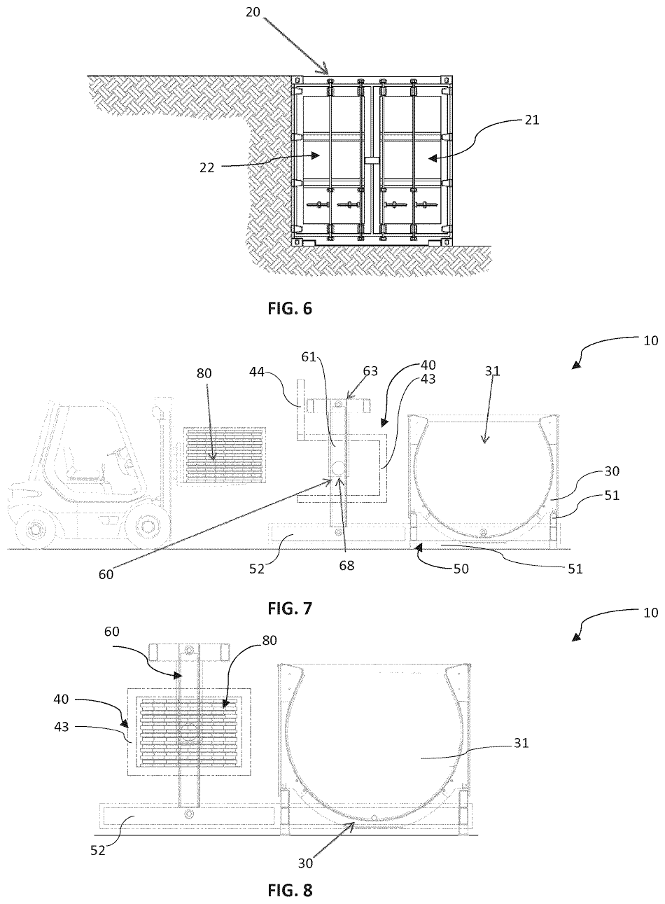

Referring to FIG. 6, which is a side elevational view of the shipping container (20) of FIGS. 1 to 3, it can be appreciated that an appropriate shipping container (20) for the treatment system (10) can be a standard shipping container (20). It can be provided with pivotable side doors (21, 22), providing access to a storage space that can contain the treatment tank (30), the item-receiving receptacle (40) and the lift (60). When stored inside the shipping container (20), the treatment system (10) can be shipped efficiently and rapidly to a treatment site. The shipping container (20) can also contain other units of the treatment system (10), if any, such as a treatment solution heating assembly, a treatment liquid flow assembly and the like. For example, and as best viewed from FIGS. 4 and 5, in the shipping container (20), the treatment tank (30), the item-receiving receptacle (40), and the lift (60) are all contained in a portion only of the shipping container (20), the portion located on the right side of the shipping container (20) in FIGS. 4 and 5. Thus, on the left side, space is available for other equipment such as heaters, pumps, hoses, pipes, power unit for actuators etc., that can be useful for the process operator. While FIGS. 4 and 5 show a non-limitative embodiment where the treatment tank (30) fills about ⅔ of the right side of the shipping container (20) and the storage space fills about ⅓ of the left side of the shipping container (20), it is understood that other configurations may be considered with different ratio of filing between the treatment tank (30) and the storage space. Thanks to the shipping container (20), the treatment system (10) can be easily stored and transported from one treatment site to another.

In use, the treatment system (10) of FIGS. 1 to 3 can be used as follows. The shipping container (20) containing the above-described equipment arrives on the treatment site. In a non-limitative embodiment, it can be installed in a location wherein its top end is substantially aligned with, i.e. at the same level, as a floor, as shown in FIGS. 1 to 3.

The shipping container (20) is configured in an open configuration, wherein it is opened at the top to provide access to the treatment tank (30). In a non-limitative embodiment, the upper wall of the shipping container (20), if any, can be removed at least partially, exposing the open top (33) of the treatment chamber (31) and providing access thereto. Then, the item-receiving receptacle (40), which can be contained in the treatment chamber (31) of the treatment tank (30) during storage and shipping, is translated upwardly, outside the treatment tank (30), as shown in FIG. 1, ready to be loaded with items, such as lignocellulosic pieces, to be treated, i.e. the item-receiving receptacle (40) is configured in the loading/unloading configuration.

The treatment chamber (31) of the treatment tank (30) can be at least partially filed with a treatment solution. The items (80) are loaded in the item-receiving receptacle (40), as shown in FIG. 2, which is then lowered down in the treatment chamber (31), as shown in FIG. 3, i.e. the item-receiving receptacle (40) is configured in the treatment configuration by configuring the lift (60) in the retracted configuration. The items (80) contained in the item-receiving receptacle (40) are then treated by immersion for a treatment duration. During the treatment duration, the item-receiving receptacle (40) can be engaged in rotation or partial rotation to promote contact between the item surfaces and the treatment solution and enhance the diffusion rate of the treatment solution towards the item surfaces. Once the treatment is completed, the item-receiving receptacle (40) is removed from the treatment chamber (31) by being displaced upwardly outside the treatment tank (30) and the shipping container (20) by configuring the lift (60) in the extended configuration. Then, the treated items (80) are discharged from the item-receiving receptacle (40), which can then be loaded with a new load of items (80) to be treated.

In an alternative embodiment, the treatment system could be configured as shown in FIGS. 1 to 3 but with the treatment tank (30), the item-receiving receptacle (40) and the lift (60) being removed from the shipping container (20).

In another alternative embodiment, shown in FIGS. 7 to 12, the treatment tank (30), the item-receiving receptacle (40) and the lift (60) can also be extracted from the shipping container (20) and mounted directly on the floor, i.e. extending upwardly from the floor, instead of being recessed with respect to the floor as shown in the non-limitative embodiment of FIGS. 1 to 3. For instance, this non-limitative embodiment can be used advantageously when the treatment site does not allow to position the top of the shipping container (20) at substantially the same level as the floor, as shown in FIGS. 1 to 3. In still another embodiment (not shown), the treatment tank (30), the item-receiving receptacle (40) and the lift (60) can remain, entirely or partially, contained inside the shipping container (20) and still be configured as shown in FIGS. 7 to 12, i.e. extending upwardly from the floor, with a lateral side of the shipping container (20) being removable entirely or partially, to provide access to the lift (60).

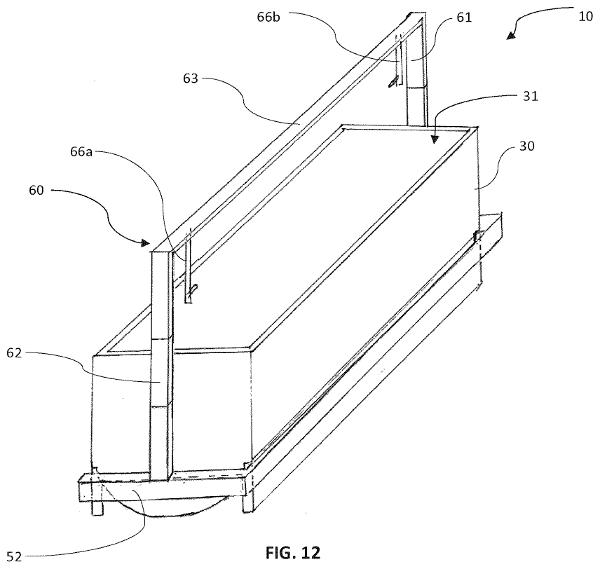

In the non-limitative embodiment of FIGS. 7 to 12, the lift (60) further comprises a slide track assembly (or drawer frame) (50) extending horizontally adjacent to the treatment tank (30) and on which the two telescopic posts (61, 62) are mounted. In the non-limitative embodiment shown, the slide track assembly (50) lies on the floor, below the treatment tank (30), with a portion, associated to a respective one of the telescopic posts (61 and 62), located on each longitudinal side of the treatment tank (30), as described below. The slide track assembly (50) comprises rails (or support stationary structure) (51) and a carriage structure (or mobile structure) (52) slidably engaged with the rails (51). The carriage structure (52) is slidable between a retracted position where the carriage structure (52) is substantially vertically aligned with the treatment tank (30) as shown in FIGS. 10 to 12, and an offset position where the carriage structure (52) is located beside of the treatment tank (30) as shown in FIGS. 7 to 9. The two telescopic posts (61 and 62) are anchored to the carriage structure (52), extending upwardly from the carriage structure (52) on each longitudinal side of the treatment tank (30), while the treatment tank (30) is mounted to a frame, which can be connected to rails (51). In the retracted position, the carriage structure (52) and the rails (51) of the slide track assembly (50) are superposed, as shown in FIG. 12.

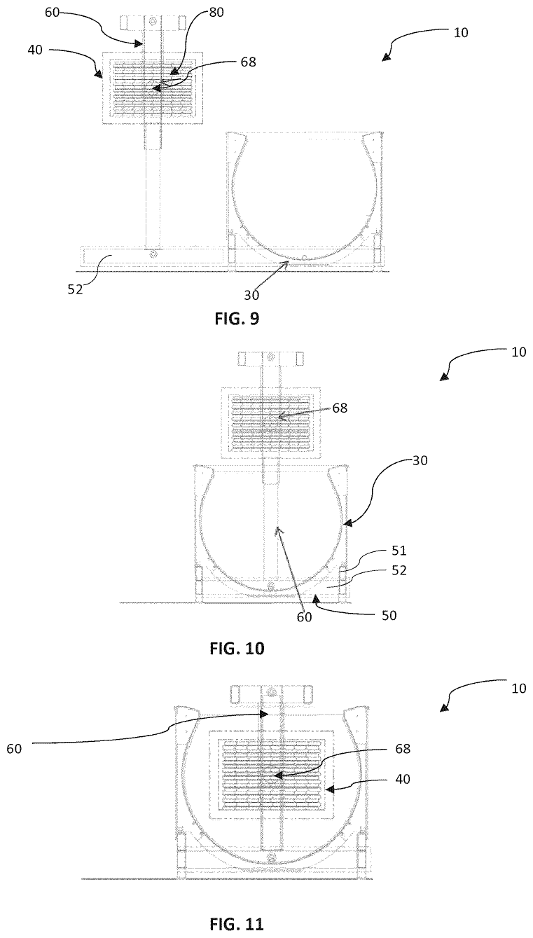

In use, the treatment system (10) of FIGS. 7 to 11 can be used as follows. In the embodiment wherein the treatment tank (30) is contained in a shipping container (20), the shipping container (20) containing the above-described equipment arrives on the treatment site. The treatment tank (30), the item-receiving receptacle (40) and the lift (60) are extracted from the shipping container (20) and installed directly on the floor at a designated location. The item-receiving receptacle (40) is translated upwardly by the lift (60) outside the treatment tank (30) (not shown), wherein a bottom of the item-receiving receptacle (40) is substantially horizontally aligned with or above a top of the shipping container (20). The treatment chamber (31) of the treatment tank (30) can be at least partially filed with a treatment solution, which can be heated if required. The carriage structure (52) of the slide track assembly (50), is slid out on one of the lateral sides of the treatment tank (30) (not shown), and then the item-receiving receptacle (40) is translated downwardly by the lift (60), wherein the item-receiving receptacle (140) is substantially horizontally aligned with the treatment tank (30), as shown in FIG. 7. The item-receiving receptacle (40) can be further provided with a door (44), as shown in FIG. 7, configurable in an open configuration allowing the items (80) to be loaded and unloaded. Such door (44) is shown in the open configuration in FIG. 7, and in a closed configuration in FIGS. 8 to 11. The items (80) are loaded in the item-receiving receptacle (40), as shown in FIG. 8, which is then translated upwardly by the lift (60), the lift (60) being configured in the extended configuration, wherein the bottom of the item-receiving receptacle (40) is substantially horizontally aligned with or above the top of the shipping container (20), and the carriage structure (52) being in an offset position where the carriage structure (52) is located beside of the treatment tank (30), as shown in FIG. 9. Then, the carriage structure (52) of the slide track assembly (50) is translated towards the treatment tank (30), i.e. in the retracted configuration, as shown in FIG. 10, to position the item-receiving receptacle (40) above the treatment tank (30) and vertically aligned with the treatment tank (30). The item-receiving receptacle (40) is then translated downwardly by the lift (60) inside the treatment chamber (31) through the open top (33), as shown in FIG. 11, in a treatment configuration. The items (80) contained in the item-receiving receptacle (40) are then treated by immersion for a treatment duration. During the treatment duration, the item-receiving receptacle (40) can be engaged in rotation or partial rotation to promote contact between the item surfaces and the treatment solution and enhance the diffusion rate of the treatment solution towards the item surfaces. Once the treatment is completed, the treated items (80) are removed from the treatment chamber (31) by sequentially translating upwardly the item-receiving receptacle (40) outside the treatment tank (30), sliding out the carriage structure (52) and lowering the item-receiving receptacle (40). Then, the treated items (80) are discharged from the item-receiving receptacle (40), which can then be loaded with a new load of items (80) to be treated.

It will be appreciated that the methods described hereinabove may be performed in the described order, or in any suitable order. For instance, the order of some of the steps can be interchanged or some steps can be carried out simultaneously.

In some non-limitative embodiments, and as best viewed in FIGS. 1, 2, 7 and 8, the item-receiving receptacle (40) comprises a cage (43) to maintain the items (80) in a bundle. The cage (43) is provided with a door (44), as shown in FIG. 7, allowing the items (80) to be loaded and unloaded. Such door (44) is shown in an open configuration in FIG. 7, and in a closed configuration in FIGS. 8 to 11. The first and second receptacle connectors (41, 42) of the item-receiving receptacle (40) (or of the lifting posts) are aligned horizontally to define an axis of rotation (68) of the cage (43), as shown in FIG. 5. The item-receiving receptacle (40) is engaged in rotation with the receptacle connector assembly (65), such that the cage (43) holding the items (80) can rotate fully or partially about the axis of rotation (68). In the treatment configuration (FIG. 5), when the cage (43) is immersed in the treatment solution, the rotation can promote an improved (higher contact rate) contact between the items to be treated (80) and the treatment solution. In the loading/unloading configuration (FIG. 4), when the cage (43) holding the treated items (80) is outside the treatment tank (30), the rotation can enhance draining of the treatment solution.

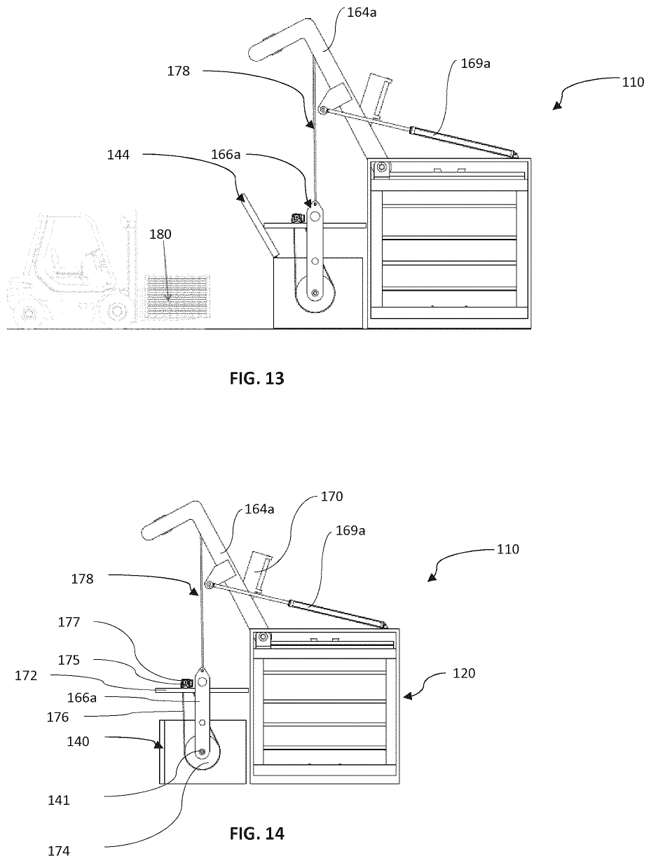

Referring to FIGS. 13 to 21, there is shown an alternative embodiment of the immersion treatment system wherein the features are numbered with reference numerals in the 100 series which correspond to the reference numerals of the previous embodiments. Several components of the immersion treatment system 110 are similar to the immersion treatment system 10 and will not be described in further details.

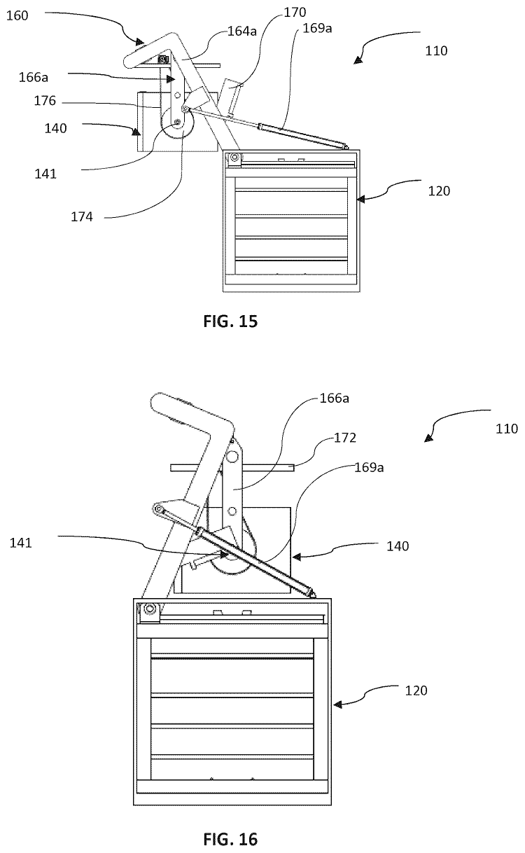

In such non-limitative embodiment, a lift (160) comprises two articulated lifting arms (164a and 164b), at least two arm actuators (169a and 169b), and a first and second receptacle support arms (166a and 166b). In the non-limitative embodiment shown, the articulated lifting arms (164a and 164b) are substantially L-shaped, with a proximal segment and a distal segment, but it is appreciated that their shape and configuration can vary from the non-limitative embodiment shown. The qualificative “proximal” is intended to mean closer to the shipping container (120) and/or the treatment tank (30) while the qualificative “distal” is intended to mean further away from the shipping container (120) and/or the treatment tank (30). A first end of the proximal segment of the articulated lifting arms (164a and 164b) is pivotally mounted to an upper portion of the shipping container (120). The articulated lifting arms (164a and 164b) can further comprise a receptacle support and translation assembly (178) connectable to the first and second receptacle support arms (166a and 166b) (FIGS. 13 to 17), and configured to support and translate the item-receiving receptacle (140) from the loading/unloading configuration (or a lowered or extended configuration), wherein a bottom of the item-receiving receptacle (140) is substantially horizontally aligned with a bottom of the shipping container (120) (see FIGS. 13, 14 and 18), to a raised configuration (or retracted), wherein the bottom of the item-receiving receptacle (140) is substantially horizontally aligned with or above the top of the shipping container (120) (see FIGS. 15, 16 and 19 to 21)., as will be more described in detail below.

In a non-limitative embodiment, the lift (160) can be dismantled from the upper portion of the shipping container (120) and therefore stored in the space available on the left side of the treatment tank (30) inside of the shipping container (120), to facilitate storage and transport of the shipping container (120) from one treatment site to another. Once installed on the treatment site, the lift (160) is at least partially taken out of the shipping container and the articulated lifting arms (164a and 164b) are mounted to the upper portion of the shipping container (120) for operating the treatment system (110).

Thus, the two articulated arms (164a and 164b) are pivotally mounted to the upper portion of the shipping container (120) and are spaced-apart from one another, on each side of the treatment tank (130), inserted in the shipping container (120). The two articulated arms (164a and 164b) are pivotable synchronously between a plurality of configurations including an engagement/disengagement configuration (FIGS. 13 to 15) wherein the articulated arms (164a and 164b) are pivoted downwardly, beside the shipping container (120), a treatment configuration (FIGS. 16 to 18) wherein the two articulated arms (164a and 164b) are vertically aligned with the treatment tank (130), and a plurality of intermediate (lifting) configurations wherein the two articulated arms (164a and 164b) transition between the engagement/disengagement configuration and the treatment configuration, as shown in FIGS. 13 to 18.

Each of the at least two arm actuators (169a and 169b) has a distal end pivotally connected to the proximal segment of a corresponding one of the two articulated arms (164a and 164b) and a proximal end pivotally connected to the upper portion of the shipping container (120), laterally opposed to the connexion between the two articulated arms (164a and 164b) and the upper end of the shipping container (120). In the non-limitative embodiment shown, the arm actuators (169a and 169b) are hydraulic cylinders, but it is appreciated that other mechanical, pneumatic, hydraulic or electric actuators can be used. The arm actuators (169a and 169b) are configurable between an extended configuration and a retracted configuration for displacing the corresponding articulated arms (164a and 164b) respectively between the engagement/disengagement configuration and the treatment configuration and vice versa.

In a non-limitative embodiment, a first longitudinal end of each of the two receptacle support arms (166a and 166b) is connected at each extremity of an horizontally extending beam (163). The two receptacle support arms (166a and 166b) both extending downwardly from the horizontally extending beam (163), in a spaced-apart configuration. More particularly, the two receptacle support arms (166a and 166b) are spaced-apart from one another by a distance such that the item-receiving receptacle (140) can be inserted in-between. In some embodiments, the horizontally extending beam (163) further comprises a top cover (172) including a covering plate being approximately of the size of the open top (133) of the treatment tank (130), and extending horizontally form each side of a lower part of the horizontally extending beam (163), such that, when the two articulated arms (164a and 164b) are in a treatment configuration with the item-receiving receptacle (140) being located inside the treatment chamber (131) of the treatment tank (130) (see FIG. 18), the top cover (172) covers the open top (133) of the treatment chamber (131) to prevent any splashes of treatment solution when the item-receiving receptacle (140) is engaged in at least a partial rotation. In an embodiment, the top cover (172) can be insulated and used to reduce heat losses.

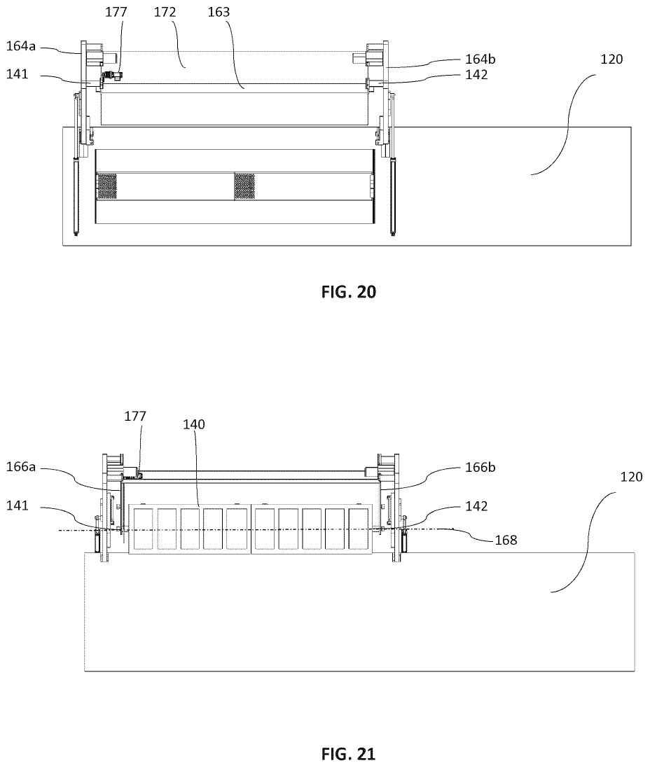

The first and second receptacle support arms (166a and 166b) further comprises first and second receptacle connectors (141, 142) mounted to a respective one of the first and second receptacle support arms (166a, 166b), at a second longitudinal ends of the first and second receptacle support arms (166a, 166b), the second longitudinal end being opposed to the first longitudinal end, as best shown in FIGS. 20 and 21. The item-receiving receptacle (140) is engageable respectively to the first and second receptacle support arms (166a and 166b) through first and second receptacle connectors (141, 142). In the non-limitative embodiment shown, the first and second receptacle connectors (141, 142) are pivot connectors configured to engage the item-receiving receptacle (140) and allow at least partial rotation about an axis defined by the first and second receptacle connectors (141, 142). It is appreciated that the item-receiving receptacle (140) is pivotally mounted to the first and second receptacle connectors (141, 142) and can be engaged in at least partial rotation inside the treatment chamber (131) to enhance diffusion and contact between the treatment solution and the items to be treated. In some embodiments, as shown in FIGS. 14 and 15, at least one of the first and second receptacle connectors (141, 142) can further comprises a chain wheel or pulley (174) mounted on the first and/or second receptacle connectors (141, 142), a sprocket or pulley (175) mounted on the top cover (172) of the horizontally extending beam (163), and a closed loop chain or belt (176) engaged around the chain wheel or pulley (174) and the sprocket or pulley (175), wherein a transmission drive (177) can be drivingly couplable to the sprocket or pulley (175), to engage the chain or belt (176) in a rotation, therefore engaging also in rotation the item-receiving receptacle (140) connected to the chain wheel or pulley (174) mounted on the first and/or second receptacle connectors (141, 142) around an axis of rotation (168) of the item-receiving receptacle (140), as shown in FIG. 21. In a non-limitative embodiment, the item-receiving receptacle (140) containing items to be treated is placed on the floor in the loading/unloading configuration, aligned substantially parallel to a lateral side of the shipping container (120), as shown in FIG. 13. The two articulated arms (164a and 164b) are deployed in the engagement/disengagement configuration by activating the two arm actuators (169a and 169b), until the distal ends of the two articulated arms are aligned vertically with the item-receiving receptacle (140). In some embodiments, the item-receiving receptacle (140) is provided with a door (144), as shown in FIG. 13, configurable in an open configuration allowing the items (180) to be loaded and unloaded. Such door (144) is shown in the open configuration in FIG. 13, and in a closed configuration in FIGS. 14 to 21.

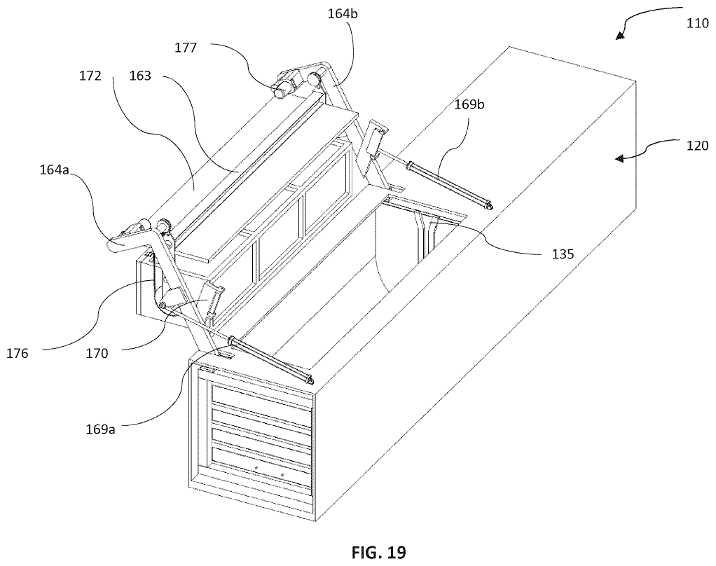

The item-receiving receptacle (140) is engageable with the first and second receptacle connectors (141, 142) mounted on the first and second receptacle support arms (166a and 166b), as shown in FIG. 14, each of the first and second receptacle support arms (166a and 166b) being connected to each of the articulated arms (164a and 164b) by the receptacle support and translation assembly (178). Such receptacle support and translation assembly can include belt/pulleys, chain/gears, cable(s), rope(s) or any other type of support assembly capable of translating the item-receiving receptacle (140) vertically with respect to the treatment tank (130). The receptacle support and translation assembly (178) is configured to translate the item-receiving receptacle (140) from an extended position, wherein a bottom of the item-receiving receptacle (140) is substantially horizontally aligned with a bottom of the shipping container (120) (see FIGS. 13, 14 and 18), to a retracted position, wherein the bottom of the item-receiving receptacle (140) is substantially horizontally aligned with or above the top of the shipping container (120) (see FIGS. 15, 16 and 19 to 21). In some embodiments, an actuator is configured to translate the receptacle support and translation assembly (178) from the extended position to the retracted position. The actuator can be a shaft drive, but it is understood that any type of mechanical, pneumatic, hydraulic or electric actuator configured to operate a hoist to retract and deploy the receptacle support and translation assembly (178) can be used. In some embodiments, a guidance rack (135) can be provided on a lateral inside face of the treatment tank (130), as shown in FIG. 19, in order to guide the item-receiving receptacle (140) during the translation of the item-receiving receptacle (140) in a treatment configuration, such as the item-receiving receptacle (140) is ensured to be centered in substantially in a middle of the treatment tank (130), preventing the item-receiving receptacle (140) from rubbing on the inner walls of the treatment tank (130) when the item-receiving receptacle (140) is engaged in rotation.

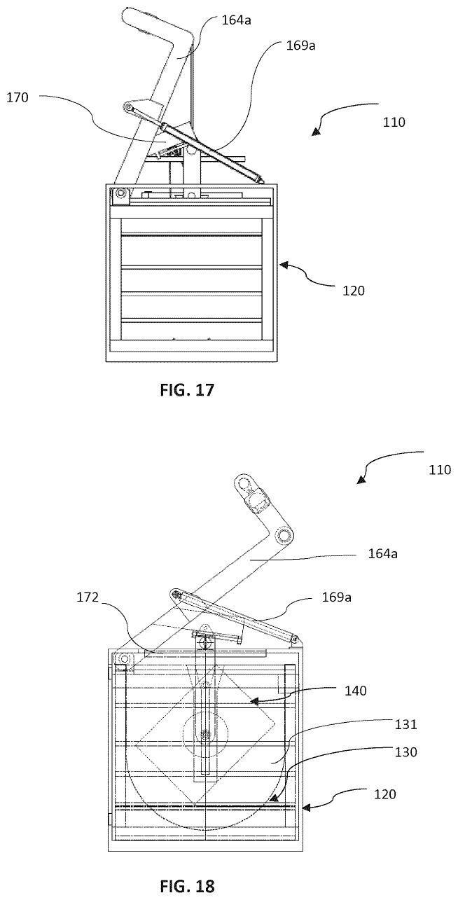

In use, the treatment system (110) of FIGS. 13 to 18 can be used as follows. The shipping container (120) containing the above-described equipment arrives on the treatment site. The lift (160) is extracted from the shipping container (120) and the articulated lifting arms (164a and 164b) are mounted to the upper portion of the shipping container (120). The item-receiving receptacle (140) is connected to the first and second receptacle connectors (141, 142), and the first and second receptacle connectors (141, 142) are connected to the articulated lifting arms (164a and 164b) by the receptacle support and translation assembly (178). The item-receiving receptacle (140) is translated upwardly by the receptacle support and translation assembly (178) at least partially mounted to the lift (160) outside the treatment tank (130) (not shown), wherein a bottom of the item-receiving receptacle (140) is substantially horizontally aligned with or above a top of the shipping container (120). The treatment chamber (131) of the treatment tank (130) can be at least partially filed with a treatment solution, which can be heated if required. The articulated lifting arms (164a and 164b) are deployed in the engagement/disengagement configuration (not shown), and then the item-receiving receptacle (140) is translated downwardly by the receptacle support and translation assembly (178), wherein the bottom of the item-receiving receptacle (140) is substantially horizontally aligned with the bottom of the shipping container (120), as shown in FIG. 13. The item-receiving receptacle (140) can be further provided with the door (144), as shown in FIG. 13. The items (180) are loaded in the item-receiving receptacle (140), as shown in FIG. 10, which is then translated upwardly by the receptacle support and translation assembly (178), the receptacle support and translation assembly (178) being in the retracted configuration, wherein the bottom of the item-receiving receptacle (140) is substantially horizontally aligned with or above the top of the shipping container (120), and the articulated lifting arms (164a and 164b) are deployed in the engagement/disengagement configuration where the item-receiving receptacle (140) is located beside of the treatment tank (130), as shown in FIG. 15. Then, the articulated lifting arms (164a and 164b) are retracted in the treatment configuration, as shown in FIG. 16, to position the item-receiving receptacle (140) above the treatment tank (130) and vertically aligned with the treatment tank (130). The item-receiving receptacle (140) is then translated downwardly by the receptacle support and translation assembly (178) inside the treatment chamber (131) through the open top (133), as shown in FIG. 17, in the treatment configuration. The items (180) contained in the item-receiving receptacle (140) are then treated by immersion for a treatment duration. During the treatment duration, the item-receiving receptacle (140) can be engaged in rotation or partial rotation to promote contact between the item surfaces and the treatment solution and enhance the diffusion rate of the treatment solution towards the item surfaces, as shown in FIG. 18. Once the treatment is completed, the treated items (180) are removed from the treatment chamber (131) by sequentially translating upwardly the item-receiving receptacle (140) outside the treatment tank (130), deploying the articulated lifting arms (164a and 164b) and lowering the item-receiving receptacle (140). Then, the treated items (180) are discharged from the item-receiving receptacle (140), which can then be loaded with a new load of items (180) to be treated.

In some non-limitative embodiment, the treatment solution contained in the treatment tank (130) can have a relatively high density (with respect to the items contained in the item-receiving receptacle (140)) and the actuator to translate downwardly/upwardly the item-receiving receptacle (140) is not sufficient to maintain the item-receiving receptacle (140) immersed in the treatment solution contained in the treatment chamber when the item-receiving receptacle (140) is in the treatment configuration. In particular, some of the items contained in the item-receiving receptacle (140) can have a high floatability. In some embodiments, an immersion plunger (170) can be provided. The immersion plunger (170) can be embodied by an articulated arm pivotally mounted on at least one of the articulated lifting arms (164a, 164b), configured to maintain the item-receiving receptacle (140) completely immerged in the treatment solution in the treatment configuration. The immersion plunger (170) applies an opposite force to the floatability force and prevents the item-receiving receptacle (140) to float, i.e. to have at least a portion thereof being located outside of the treatment solution contained in the treatment chamber (131). The opposite force applied by the immersion plunger (170) can result from a hydraulic actuator, pneumatic actuator, electric actuator, mechanical actuator, or any other type of actuators, from gravity, or from any other means to apply a force.

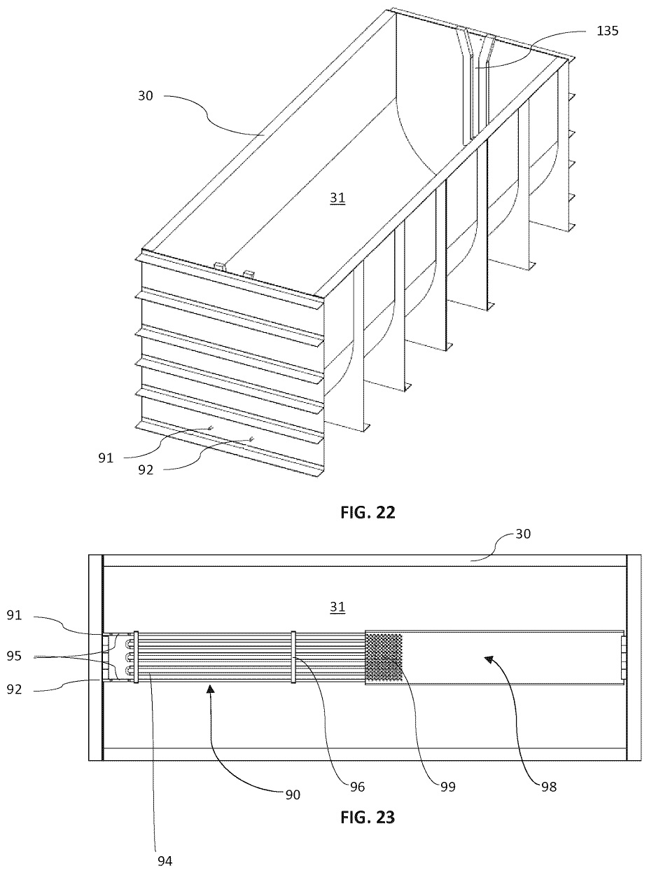

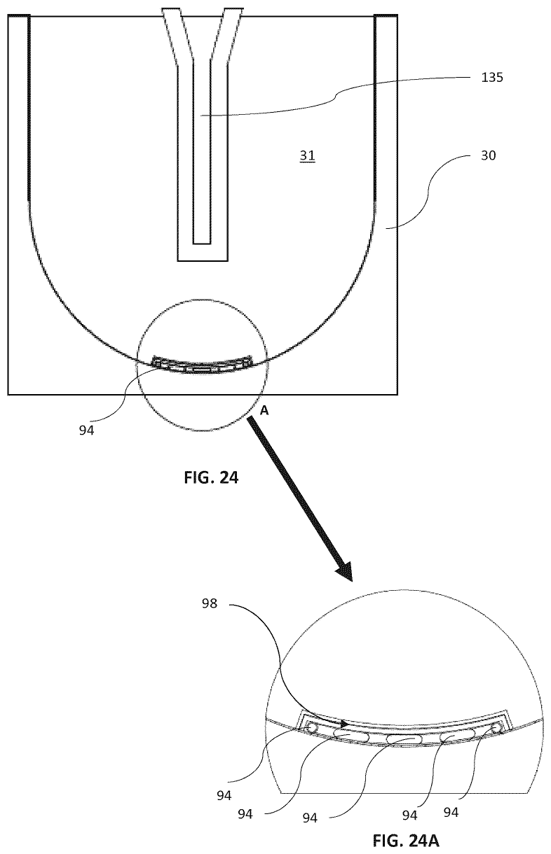

In another non-limitative embodiment, as shown in FIGS. 22 to 24A, the treatment system (10, 110) comprises a treatment solution heating assembly to heat the liquid-based treatment solution above the ambient temperature for item treatment. In such case, the walls of the treatment tank (30), i.e. the walls that define and delimit the treatment chamber (31), can be heat-insulated. In a non-limitative embodiment, the treatment solution heating assembly can include a heat exchanger (90) having a section extending inside the treatment chamber (31) of the treatment tank (30). In some embodiments, the heat exchanger (90) comprises a conduit (94), such as but not exclusively in the form of a serpentine tube as best shown in FIG. 23, and disposed all along a bottom of the treatment tank (30) as shown in FIG. 24. The conduit (94) can be made of copper, aluminum, galvanized steel, stainless steel, or any material that is characterized by a high heat exchange coefficient and is resistant to the treatment solution contained in the treatment tank (30). The treatment solution heating assembly can further comprise support racks (96), extending upwardly from the bottom of the treatment tank (30), spaced apart from each other, and supporting the heat exchanger conduit (94). These support racks (96) prevent the heat exchanger conduit (94) from being in direct contact with the bottom of the treatment tank (30) and allow the treatment solution to circulate around the conduit (94) for increased heat exchange.

In some embodiments, the treatment solution heating assembly can further comprise a protective cover (98), located above and covering the conduit (94) as best shown in FIG. 24A, to prevent any damage on the heat exchanger. The protective cover (98) can be made of copper, aluminum, galvanized steel, stainless steel, or any material that is characterized by a high heat exchange coefficient and is resistant to the treatment solution contained in the treatment tank (30), and further comprises a plurality of holes (99) to allow the treatment solution circulation around the conduit (94) for increased heat exchange.

Each end of the conduit (94) can be connected, via pipe connectors (95), which can be made of flexible material for easy maintenance, to a heat transfer fluid inlet (91) and a heat transfer fluid outlet (92), respectively. The treatment solution heating assembly can further include a heating unit (not shown) configured to heat the heat transfer fluid (such as oil) circulating between the inlet (91) and the outlet (92). The heating unit can be contained in the shipping container (20), for instance, and without being limitative, beside the treatment tank (30), and be in fluid communication with the heat exchanger (90) via the inlet (91) and the outlet (92) to heat the heat transfer fluid flowing therein. As it is appreciated, the heat transfer fluid can circulate, propelled by a pump, in a closed loop between the heat exchanger (90) and the heating unit. As the heating unit, the pump, which is included in the treatment solution heating assembly, can be contained in the shipping container (20), for instance, and without being limitative, beside the treatment tank (30) and the heating unit.

In some embodiments (not shown), the heat exchanger can be located inside the walls of the treatment tank (30).

In another non-limitative embodiment, the shipping container (20) can be provided with external inlets and outlets (not shown), to allow the treatment solution heating assembly and the cage lift to be supplied with water, carburant or electricity.

Referring to FIG. 25, a method (200) for treating items by immersion is shown, according to a non-limitative embodiment.

A first step of the method (200) can include providing an immersion treatment system as defined in any embodiments described above. The step of providing the immersion system can further comprises installing the immersion system in a suitable location. It is understood that the immersion treatment system according to the first non-limitative embodiment as described in FIGS. 1 to 6, the immersion treatment system according to the second non-limitative embodiment as described in FIGS. 7 to 12, the immersion treatment system according to the third non-limitative embodiment as described in FIGS. 13 to 18, or any other immersion system for treating items can be used. The step of providing the immersion system can further comprises removing the treatment tank, the item-receiving receptacle and the lift from the shipping container and mounting them directly to the floor, i.e. extending upwardly from the floor, as shown in FIGS. 7 to 11.

Optionally, a second step of the method (200) can comprise displacing the item-receiving receptacle from the treatment configuration to the loading/unloading configuration, if the item-receiving receptacle is contained inside the treatment chamber. In the present non-limitative embodiment, the immersion treatment system is initially provided with the item-receiving receptacle being in the treatment configuration. The step of displacing the item-receiving receptacle from the treatment configuration to the loading/unloading configuration can be performed by activating the actuators and/or the lift to:
slide in sync upwardly the two telescopic posts (61, 62) into the extended configuration, as shown in FIGS. 1 to 6;
slide in sync upwardly the two telescopic posts (61, 62) into the extended configuration, slide out the carriage structure (52) in the offset position where the carriage structure (52) is located beside of the treatment tank, and slide in sync downwardly the two telescopic posts (61, 62) into the retracted configuration, as shown in FIGS. 7 to 12; or
pivot synchronously downwardly the two articulated arms (164a and 164b) into the engagement/disengagement configuration, where the articulated arms (164a and 164b) are pivoted downwardly, beside the shipping container (120) to engage/disengage with and from the item-receiving receptacle (140) supported on the floor, as shown in FIGS. 13 to 18.

A third step of the method (200) can comprise loading items in the item-receiving receptacle. In some non-limitative embodiments, the item-receiving receptacle can further comprise a cage to maintain the items in a bundle. In such non-limitative embodiment, loading items in the item-receiving receptacle can further comprise opening a door of the cage; loading the items in the cage; and closing the door, to ensure that all items to be treated are properly bundled.

A fourth step of the method (200) can comprise displacing the item-receiving receptacle from the loading/unloading configuration to the treatment configuration. The step of displacing the item-receiving receptacle from the treatment configuration to the loading/unloading configuration can be performed by activating the actuators and/or the lift to:
slide in sync downwardly the two telescopic posts (61, 62) into the retracted configuration, as shown in FIGS. 1 to 6;
slide in sync upwardly the two telescopic posts (61, 62) into the extended configuration, slide in the carriage structure (52) in the retracted position where the carriage structure (52) is substantially vertically aligned with the treatment tank (30), and slide in sync downwardly the two telescopic posts (61, 62) into the retracted configuration, as shown in FIG. 7 to 12; or
pivot synchronously upwardly the two articulated arms (164a and 164b) into the retracted configuration, where the item-receiving receptacle (140) is positioned above the treatment tank (130), and translate the item-receiving receptacle (140) downwardly inside the treatment tank (130), as shown in FIGS. 13 to 18.

A fifth step of the method (200) can comprise treating the items with the treatment solution contained in the treatment chamber and obtaining treated items. The step of treating the items can further comprise engaging the item-receiving receptacle in rotation or partial rotation about an axis defined by the first and second receptacle connectors. It is appreciated that the item-receiving receptacle can rotate about the first and second receptacle connectors or that the first and second receptacle connectors can rotate about the first and second receptacle support arms. The rotation or partial rotation of the item-receiving receptacle promote contact between the item surfaces and the treatment solution and enhance the diffusion rate of the treatment solution towards the item surfaces.

The step of treating the items can further comprise heating the treatment solution.

A sixth step of the method (200) can comprise displacing the item-receiving receptacle from the treatment configuration to the loading/unloading configuration. The step of displacing the item-receiving receptacle from the treatment configuration to the loading/unloading configuration can be performed by activating the actuators and/or the lift to:
slide in sync upwardly the two telescopic posts (61, 62) into the extended configuration, as shown in FIGS. 1 to 6;
slide in sync upwardly the two telescopic posts (61, 62) into the extended configuration, slide out the carriage structure (52) in the offset position where the carriage structure (52) is located beside of the treatment tank, and slide in sync downwardly the two telescopic posts (61, 62) into the retracted configuration, as shown in FIGS. 7 to 12; or
pivot synchronously downwardly the two articulated arms (164a and 164b) into the engagement/disengagement configuration, where the articulated arms (164a and 164b) are pivoted downwardly, beside the shipping container (120) to engage/disengage with and from the item-receiving receptacle (140) supported on the floor, as shown in FIGS. 13 to 18.

The step of displacing the item-receiving receptacle from the treatment configuration to the loading/unloading configuration can further comprise an intermediate step of holding the item-receiving receptacle outside the treatment tank and above the treatment tank and rotating at least partially the item-receiving receptacle to enhance draining of the treatment solution.

A seventh step of the method (200) can comprise unloading the treated items from the item-receiving receptacle. The step of unloading the treated items from the item-receiving receptacle can further comprise waiting for the items to be substantially dried before unloading the treated items.

Several alternative embodiments and examples have been described and illustrated herein. The embodiments described above are intended to be exemplary only. A person of ordinary skill in the art would appreciate the features of the individual embodiments, and the possible combinations and variations of the components. A person of ordinary skill in the art would further appreciate that any of the embodiments could be provided in any combination with the other embodiments disclosed herein. It is understood that the system described herein may be embodied in other specific forms without departing from the central characteristics thereof. The present examples and embodiments, therefore, are to be considered in all respects as illustrative and not restrictive, and the system and method is not to be limited to the details given herein. Accordingly, while the specific embodiments have been illustrated and described, numerous modifications come to mind. The scope of the system and method is therefore intended to be limited solely by the scope of the appended claims.

1. An immersion treatment system for treating items, the immersion treatment system comprising:
a shipping container;
a treatment tank insertable in the shipping container and defining a treatment chamber, the treatment chamber being adapted to receive a treatment solution;
an item-receiving receptacle displaceable between a loading/unloading configuration where the item-receiving receptacle extends outside the treatment chamber and a treatment configuration where the item-receiving receptacle is positioned in the treatment chamber; and
a lift at least partially insertable in the shipping container and including a receptacle connector assembly, and wherein the item-receiving receptacle is being engageable with the receptacle connector assembly and translatable between the loading/unloading configuration and the treatment configuration.

2. The immersion treatment system as defined in claim 1, wherein the lift comprises:
two telescopic posts extending vertically, the receptacle connector assembly being connected to the telescopic posts and configured to receive the item-receiving receptacle in between, each one of the two telescopic posts being slidable in sync between an extended configuration and a retracted configuration; and
an actuation assembly operatively connected to the two telescopic posts to configure the two telescopic posts between the retracted configuration and the extended configuration.

3. The immersion treatment system as defined in claim 2, wherein the lift comprises:
a horizontally extending beam mounted to the two telescopic posts and extending between an upper segment of each of the two telescopic posts; and
wherein the receptacle connector assembly comprises a first receptacle support arm and a second receptacle support arm both extending downwardly from the horizontally extending beam, the item-receiving receptacle being engageable with the first receptacle support arm and the second receptacle support arm at opposed longitudinal ends thereof.

4. The immersion treatment system as defined in claim 3, wherein the two telescopic posts being in the extended configuration corresponds to the loading/unloading configuration when the item-receiving receptacle is engaged with the receptacle connector assembly, and
wherein the two telescopic posts being in the retracted configuration corresponds to the treatment configuration when the item-receiving receptacle is engaged with the receptacle connector assembly.

5. The immersion treatment system as defined in claim 3, wherein the lift further comprises a slide track assembly extending horizontally adjacent to the treatment tank, the slide track assembly comprising a rail structure and a carriage structure, the carriage structure being slidable between an aligned position where the carriage structure is vertically aligned with the treatment tank and an offset position where the carriage structure is located on a lateral side of the treatment tank, the two telescopic posts being mounted to the carriage structure.

6. The immersion treatment system as defined in claim 5, wherein the two telescopic posts being in the retracted configuration and the carriage structure being in the offset position corresponds to the loading/unloading configuration when the item-receiving receptacle is engaged with the receptacle connector assembly, and
wherein the two telescopic posts being in the retracted configuration and the carriage structure being in the aligned position corresponds to the treatment configuration when the item-receiving receptacle is engaged with the receptacle connector assembly.

7. The immersion treatment system as defined in claim 1, wherein the lift comprises:
articulated arms pivotally securable to the shipping container, the receptacle connector assembly being connectable to the articulated arms and configured to receive the item-receiving receptacle in between, each one of the articulated arms being pivotable in sync and selectively configurable between an engagement/disengagement configuration to engage the item-receiving receptacle configured in the loading/unloading configuration and a treatment configuration wherein the articulated arms are vertically substantially aligned with the treatment tank; and
at least one arm actuator operatively connected to the articulated arms and being actuable to configure the articulated arms selectively in the engagement/disengagement configuration and the treatment configuration.

8. The immersion treatment system as defined in claim 1, wherein the item-receiving receptacle comprises a cage to maintain the items in a bundle, the cage including a door configurable in an open configuration allowing the items to be loaded and unloaded.

9. The immersion treatment system as defined in claim 1, wherein the item-receiving receptacle is rotatably mounted to the receptacle connector assembly.

10. The immersion treatment system as defined in claim 1, wherein the treatment tank comprises an open top communicating with the treatment chamber allowing access to the item-receiving receptacle.

11. The immersion treatment system as defined in claim 1, further comprising a treatment solution heating assembly.

12. A method for treating items by immersion, comprising the steps of:
providing an immersion treatment system;
loading items in the item-receiving receptacle;
displacing the item-receiving receptacle from the loading/unloading configuration to the treatment configuration;
treating the items with the treatment solution contained in the treatment chamber and obtaining treated items;
displacing the item-receiving receptacle from the treatment configuration to the loading/unloading configuration; and
unloading the treated items from the item-receiving receptacle.

13. The method as defined in claim 12, wherein the step of loading items in the item-receiving receptacle further comprises a step of displacing the item-receiving receptacle from the treatment configuration to the loading/unloading configuration if the item-receiving receptacle is in the treatment configuration.

14. The method as defined in claim 12, wherein the item-receiving receptacle comprises a cage to maintain the items in a bundle; and
wherein the step of loading items in the item-receiving receptacle further comprises loading the items through a door in the cage.

15. The method as described in claim 14, wherein the step of unloading the treated items from the item-receiving receptacle further comprises unloading the items through the door in the cage.

16. The method as defined in claim 12, wherein the step of treating the items with the treatment solution contained in the treatment chamber further comprises rotating the item-receiving receptacle in the treatment chamber.

17. The method as defined in claim 12, wherein the step of displacing the item-receiving receptacle from the treatment configuration to the loading/unloading configuration further comprises the step of holding the item-receiving receptacle outside the treatment tank and above the treatment tank to drain the treatment solution.

18. The method as defined in claim 12, further comprising the step of heating the treatment solution.
